(19) United States
(12) Patent Application Publication
(10) Pub. No.: US 2026/0059531 A1
(43) Pub. Date: Feb. 26, 2026

(54) APPARATUS AND METHODS FOR COHERENT PHASE RESOURCE ALLOCATION IN MULTI-BEAM CARRIER COMMUNICATION SYSTEMS

(71) Applicant: QUALCOMM Incorporated, San Diego, CA (US)

(72) Inventors: Alexandros MANOLAKOS, Athens (GR); Mukesh KUMAR, Hyderabad (IN)

(21) Appl. No.: 19/104,652

(22) PCT Filed: Sep. 11, 2023
(86) PCT No.: PCT/US2023/073861

§ 371 Date: Feb. 18, 2025

(30) Foreign Application Priority Data
Oct. 19, 2022 (GR) 20220100860

(51) Int. Cl. H04W 72/21; H04L 5/00; H04W 64/00

(52) U.S. Cl. CPC H04W 72/21; H04L 5/0094; H04W 64/006

(57) ABSTRACT

Methods, systems, and apparatuses to provide phase coherent resources in multi-beam wireless communication systems. For example, a computing device generates a configuration request message for resources with phase coherency. The computing device also transmits the configuration request message to at least one base station. Further, the computing device receives a configuration response message from the at least one base station, where the configuration response message identifies a plurality of resources with phase coherency. The computing device then generates assistance data based on the plurality of resources with phase coherency. Further, the computing device transmits the assistance data, such as to one or more user equipment.

### BACKGROUND

### Field of the Disclosure

This disclosure relates generally to wireless communication systems and, more specifically, to coherent carrier phase resource allocations in multi-beam wireless communication systems.

### Description of Related Art

Wireless communication systems can provide various telecommunications services including, for example, audio, video, data, messaging, and network access, among other others. For instance, wireless communication systems may allow for communications among various devices, such as Internet of Things (IoT) devices. These wireless communication systems can be based on various technologies, such as code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TDSCDMA) systems, Long Term Evolution (LTE) systems, WiMax systems, and Evolved High Speed Packet Access (HSPA+) systems. These and other wireless communication systems may conform to a standard, such as the third generation (3G) of broadband cellular network technology, the fourth generation (4G) of broadband cellular network technology, and more recently the fifth generation (5G) of broadband cellular network technology (also known as New Radio (NR)).

A wireless communication system may include a number of base stations (BSs) that allow communication for a number of user equipment (UE). For example, a UE may receive data from a BS in a downlink, and may transmit data to a BS in an uplink. The data exchanged during uplinks and downlinks may be transmitted using a carrier operating within a frequency spectrum. A receiving device, such as a BS receiving an uplink or a UE receiving a downlink, receives the uplink or downlink at a phase of the carrier. The wireless communication system may also provide location services. For instance, the wireless communication system may include a location management function (LMF) that can provide location services to UEs.

### SUMMARY

According to one aspect, a method includes generating a configuration request message for resources with phase coherency. The method also includes transmitting the configuration request message to at least one base station, the configuration request message causing the at least one base station to determine a plurality of resources with phase coherency. Further, the method includes receiving a configuration response message from the at least one base station, wherein the configuration response message identifies a plurality of resources with phase coherency. The method also includes generating assistance data based on the plurality of resources with phase coherency. The method further includes transmitting the assistance data.

According to another aspect, an apparatus comprises a non-transitory, machine-readable storage medium storing instructions, and at least one processor coupled to the non-transitory, machine-readable storage medium. The at least one processor is configured to generate a configuration request message for resources with phase coherency. The at least one processor is also configured to transmit the configuration request message to at least one base station, the configuration request message causing the at least one base station to determine a plurality of resources with phase coherency. Further, the at least one processor is configured to receive a configuration response message from the at least one base station, wherein the configuration response message identifies a plurality of resources with phase coherency. The at least one processor is also configured to generate assistance data based on the plurality of resources with phase coherency. The at least one processor is further configured to transmit the assistance data.

According to another aspect, a non-transitory, machine-readable storage medium stores instructions that, when executed by at least one processor, causes the at least one processor to perform operations that include generating a configuration request message for resources with phase coherency. The operations also include transmitting the configuration request message to at least one base station, the configuration request message causing the at least one base station to determine a plurality of resources with phase coherency. Further, the operations include receiving a configuration response message from the at least one base station, wherein the configuration response message identifies a plurality of resources with phase coherency. The operations also include generating assistance data based on the plurality of resources with phase coherency. The operations further include transmitting the assistance data.

According to another aspect, an apparatus includes a means for generating a configuration request message for resources with phase coherency. The apparatus also includes a means for transmitting the configuration request message to at least one base station, the configuration request message causing the at least one base station to determine a plurality of resources with phase coherency. Further, the apparatus includes a means for receiving a configuration response message from the at least one base station, wherein the configuration response message identifies a plurality of resources with phase coherency. The apparatus also includes a means for generating assistance data based on the plurality of resources with phase coherency. The apparatus further includes a means for transmitting the assistance data.

### BRIEF DESCRIPTION OF DRAWINGS

FIG. 1 is a block diagram of an exemplary wireless communication system, according to some implementations;

FIG. 2 is a block diagram of an exemplary network device, according to some implementations;

FIGS. 3A, 3B, 4A, and 4B illustrate communications among networked devices, according to some implementations;

FIG. 5 is a flowchart of an exemplary process for generating assistance data that identifies resources with phase coherency, according to some implementations; and

FIG. 6 is a flowchart of an exemplary process for generating a resource request message for resources with phase coherency, according to some implementations.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

Base stations (BSs), which may also be referred to as a Node B, a gNB, a transmit receive point (TRP), an access point (AP), and the like, when operating in a wireless communication system such as New Radio (NR), may transmit positioning reference signals (PRSs) that user equipments (UEs) may detect to determine their location. For instance, NR may support one or more UE assisted or UE based positioning methods, such as multi-cell round trip time (multi-RTT) positioning, downlink time difference of arrival (DL-TDOA) positioning, and downlink angle of departure (DL-AoD) positioning methods. To determine its position, a UE may receive assistance data, such as from a location management function (LMF), that identifies downlink PRS resources (e.g., DL-PRS resources).

For instance, DL-PRS may include up to four frequency layers, where each frequency layer may identify up to sixty-four TRPs. Further, for each TRP, DL-PRS may identify two PRS resource sets, where each PRS resource set may include up to sixty-four PRS resources. In some examples, an LMF may generate the assistance data such that the up to four frequency layers are in order of priority (e.g., a decreasing order of measurement priority, such as where the first frequency layer in the assistance data has highest priority, and the last frequency layer in the assistance data has least priority), the up to sixty-four TRPs for each frequency layer are in order of priority, the two PRS resource sets for each TRP are in order of priority, and the sixty-four resources of each PRS resource set are in order of priority.

A base station may configure a DL-PRS resource to a number of slots. The allocation of the DL-PRS resource to the number of slots may include, for instance, a periodicity of the DL-PRS resource (e.g., how many slots from a first slot of the DL-PRS resource to a second slot of the same DL-PRS resource), and a slot offset (e.g., how many slots until the first slot for the DL-PRS resource). The allocation may also include one or more of a resource repetition value (e.g., a number of repeated slots for the DL-PRS resource) and a time gap value (e.g., a maximum number of slots between two consecutive resource slots of a same DL-PRS resource). The base station may transmit DL-PRS configurations to, for example, a location management function (LMF).

In some implementations, a base station (e.g., a TRP) generates and transmits DL-PRS configuration data characterizing a phase coherency between DL-PRS resources. For instance, the DL-PRS configuration data may identify DL-PRS resources with a same initial transmission phase. In some examples, the DL-PRS configuration data identifies one or more of a repetition value and a time gap value for the DL-PRS resources with phase coherency.

In some implementations, and during a PRS configuration exchange, an LMF may generate a DL-PRS configuration request message that includes a request for DL-PRS configurations that include DL-PRS resources with phase coherency. The DL-PRS configuration request message may further specify one or more of a repetition value and a maximum time gap value for the DL-PRS resources with phase coherency. The DL-PRS configuration request message may also include a request for the DL-PRS resources to use a same antenna port. For instance, the DL-PRS configuration request message may include a first data field (e.g., one bit, a “coherency flag”) that indicates a request for DL_PRS configurations with resource coherency. The DL-PRS configuration request message may also include a second data field (e.g., another bit) that indicates a request for the DL-PRS resources to be on a same antenna port. Further, the DL-PRS configuration request message may include a third data field that identifies a repetition value, and a fourth field that identifies a time gap value, requested for the DL-PRS resources with phase coherency. The LMF may transmit the DL-PRS configuration request message to a base station.

In response to receiving a DL-PRS configuration request message, a base station may determine DL-PRS configurations with DL-PRS resources that have a same initial transmission phase coherency, and may generate a DL-PRS configuration response message that identifies DL-PRS resources with the same initial transmission phase coherency. In some examples, the base station determines DL-PRS configurations that have DL-PRS resources with initial transmission phases that are within a range, and generates a DL-PRS configuration response message that identifies the DL-PRS resources with the initial transmission phases within the threshold. In some examples, the base station generates the DL-PRS configuration response message to also identify, for each DL-PRS resource, an antenna port, a repetition value, and a time gap value. The base station may transmit the DL-PRS configuration response message to the LMF.

The LMF may receive the DL-PRS configuration response message, and may extract the repetition value and the time gap value from the DL-PRS configuration response message. The received repetition value and time gap value may, or may not, correspond to the requested repetition value and time gap value (e.g., based on the DL-PRS resources available to the base station). For instance, the LMF may request, within the DL-PRS configuration request message, a repetition value of four for DL-PRS resources with phase coherency, but the base station may only manage to assign two repeating slots for a DL-PRS resource with phase coherency. In some examples, the base station allocates DL-PRS resources (e.g., slots) in accordance with the DL-PRS configuration request message.

In some implementations, the LMF generates assistance data that identifies the DL-PRS resources with initial transmission phase coherency. For instance, the assistance data may identify DL-PRS resources with a same initial transmission phase. The LMF may also generate assistance data that identifies the repetition value and time gap value received from a base station for the DL-PRS resources. In some examples, the LMF determines any of the DL-PRS resources that satisfy one or more of the repetition value and the time gap value in the DL-PRS configuration request message transmitted to the base station, and generates the assistance data to identify the determined DL-PRS resources. The LMF may transmit (e.g., broadcast) the assistance data to one or more UEs.

In some instances, the LMF generates assistance data that identifies one or more DL-PRS configurations. The assistance data may include a profile identification (ID) for each of the DL-PRS configurations. The LMF may transmit the assistance data to a UE, and the UE may select one of the DL-PRS configurations. For example, the UE may identify the selected one of the DL-PRS configurations by generating a profile selection message, such as a request assistance data message, that includes the profile ID for the selected DL-PRS configuration, and may transmit the profile selection message to the LMF. The LMF may then configure a base station based on the selected DL-PRS configuration. For instance, in response to receiving the profile selection message, the LMF may generate a DL-PRS configuration request in accordance with the profile identified within the profile selection message, and may transmit the DL-PRS configuration request to the base station, as described herein.

In some implementations, a UE generates a request for assistance data that includes a request for DL-PRS configurations with phase coherent DL-PRS resources. The UE may transmit the request assistance data to an LMF. In response, the LMF may generate and transmit assistance data that identifies DL-PRS resources that are phase coherent, as described herein. In some examples, the UE can improve its positioning measurement performance by utilizing DL-PRS resources that are phase coherent. For example, the UE may prioritize resources based on carriers identified as having similar initial phases and, as a result, the UEs may minimize phase errors based on the UE's location. Persons of ordinary skill in the art having the benefit of these disclosures would recognize these and other benefits as well.

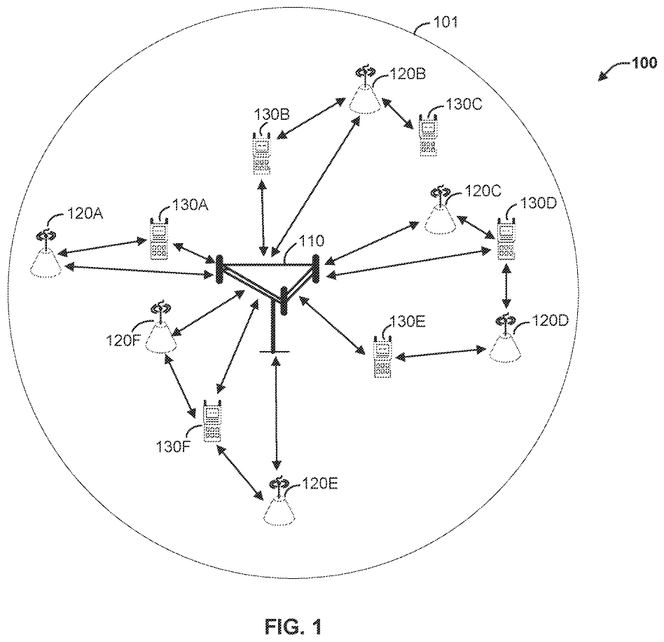

FIG. 1 is a block diagram of at least portions of an exemplary wireless communication system 100, such as a 5G wireless communication system. Wireless communication system 100 includes at least one BS 110 (e.g., a TRP, a gNB), a plurality of UEs 130, and a plurality of LMFs 120. Although wireless communication system 100 may include additional components, such as access and mobility management functions (AMFs), session management functions (SMF), relay stations, and any other suitable components, they are not illustrated for simplicity purposes.

Each UE may be, for example, a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), an Internet telephone, a digital camera, a digital video recorder, a handheld device, such as a portable video game device or a personal digital assistant (PDA), a drone device, a virtual reality device (e.g., a virtual reality headset), an augmented reality device (e.g., augmented reality glasses), or any other suitable device. BS 110 may provide communication coverage for a particular geographical area, such as geographical area 101. For example, geographical area 101 may correspond to a macro cell, a pico cell, a femto cell, or any other type of cell. To provide coverage, BS 110 may transmit one or more beams that cover at least portions of geographical area 101. Each beam may include one or more carriers that operate within a frequency spectrum. For example, BS 110 may transmit data, such as PRS, within downlinks to UEs 130 using the one or more carriers associated with each beam.

BS 110 may also communicate with LMFs 120. For example, LMFs 120 may request and receive information, such as DL-PRS configurations, from each BS 110. For instance, LMF 120 may generate a DL-PRS configuration request message that includes a request for DL-PRS configurations that include DL-PRS resources with phase coherency. The DL-PRS configuration request message may, in some examples, specify one or more of a repetition value and a time gap value for the DL-PRS resources with phase coherency. For instance, the DL-PRS configuration request may include a request for a maximum number of slots that are phase coherent. The DL-PRS configuration request message may also include a request for the DL-PRS resources to use a same antenna port. LMF 120 may transmit the DL-PRS configuration request message to BS 110.

In response to receiving a DL-PRS configuration request message, BS 110 may determine DL-PRS configurations with DL-PRS resources that are phase coherent (e.g., DL-PRS resources that are transmitted with carriers that have a same initial transmission phase), and may generate a DL-PRS configuration response message that identifies the phase coherent DL-PRS resources. In some examples, BS 110 determines DL-PRS configurations that have DL-PRS resources with initial transmission phases that are within a range, and generates a DL-PRS configuration response message that identifies the DL-PRS resources with the initial transmission phases within the threshold. In some examples, BS 110 generates a DL-PRS configuration response message that identifies, for each DL-PRS resource, an antenna port, a repetition value, and a time gap value. BS 110 may transmit the DL-PRS configuration response message to LMF 120 in response to the DL-PRS configuration request message.

LMFs 120 may also receive measurement information from any connected UEs 130. Based on the operating mode (e.g., either UE-based or UE-assisted modes), the measurement information may include, for example, one or more of location information (e.g., latitude, longitude, and altitude data), velocity data, reference time data, code phase and Doppler measurements, and carrier phase measurements, among others. Further, LMFs 120 can provide support location services to connected UEs 130. For example, as illustrated, UE 130a is in communication with LMF 120a, and thus LMF 120A can provide location services to UE 130a. Similarly, UEs 130b and 130c are in communication with LMF 120b, and thus LMF 120b can provide location services to UEs 130b, 130c. UE 130d is in communication with each of LMF 120c and LMF 120d, and can receive location services from LMFs 120c, 120d. UE 130e is in communication with, and can receive location services from, LMF 120d. Similarly, UE 130f is in communication with each of LMF 120e and LMF 120f, and thus can receive location services from LMFs 120e, 120f.

Based on measurement information received from UEs 130 as well as information received from BS 110, LMFs 120 can generate and transmit (e.g., broadcast) assistance data to connected UEs 130. The assistance data may include, for example, reference times, reference locations, ionospheric models, earth orientation parameters, time offsets, differential corrections, Ephemeris and Clock Models, health status, data bit assistance, acquisition assistance, almanac, UTC models, and resource data identifying resources, such as DL-PRS resources, that are phase coherent. The resource data may also include, in some examples, one or more of an antenna port, a repetition value, and time gap value for the DL-PRS resources.

In some examples, a UE 130, such as UE 130a, generates a request for assistance data that includes a request for DL-PRS configurations with phase coherent DL-PRS resources. UE 130a may transmit the request for assistance data to LMF 120a. In response, LMF 120a may generate and transmit, to UE 130a, assistance data that identifies DL-PRS resources for BS 110 that are phase coherent (e.g., an assistance data update).

In some instances, an LMF 120 generates assistance data that identifies one or more DL-PRS configurations as received, for instance, from BS 110. The assistance data may include a profile ID for each of the DL-PRS configurations. LMF 120 may transmit the assistance data to a UE 130. In response to receiving the assistance data, the UE 130 may select one of the DL-PRS configurations, and may generate a profile selection message that includes the profile ID for the selected DL-PRS configuration. The UE 130 may transmit the profile selection message to the LMF 120. In response to receiving the profile selection message, the LMF 120 may configure BS 110 based on the selected DL-PRS configuration. For instance, LMF 120 may generate a DL-PRS configuration request in accordance with the profile identified within the profile selection message, and may transmit the DL-PRS configuration request to BS 110.

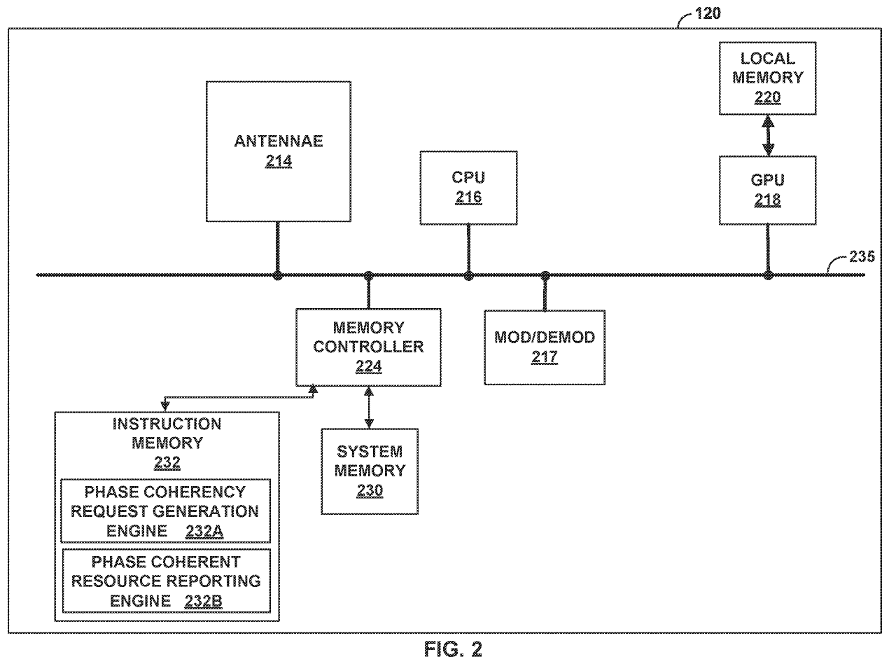

FIG. 2 illustrates a block diagram of an exemplary LMF 120. The functions of LMF 120 may be implemented in one or more processors, one or more field-programmable gate arrays (FPGAs), one or more application-specific integrated circuits (ASICs), one or more state machines, digital circuitry, any other suitable circuitry, or any suitable hardware. LMF 120 may perform one or more of the exemplary functions and processes described in this disclosure. For example, the functions of LMF 120 may be implemented across one or more servers, such as one or more cloud-based servers, or any other suitable computing devices.

As illustrated in the example of FIG. 2, LMF 120 may include an antenna 215, which may be an antenna array, a central processing unit (CPU) 216, a modulator/demodulator 217, a graphics processing unit (GPU) 218, a local memory 220 of GPU 218, and a memory controller 124 that provides access to system memory 230 and to instruction memory 232.

Memory controller 224 may be communicatively coupled to system memory 230 and to instruction memory 232. Memory controller 224 may facilitate the transfer of data going into and out of system memory 230 and/or instruction memory 232. For example, memory controller 224 may receive memory read and write commands, such as from CPU 216 or GPU 218, and service such commands to provide memory services to system memory 230 and/or instruction memory 232. Although memory controller 224 is illustrated as being separate from both CPU 216 and system memory 230, in other examples, some or all of the functionality of memory controller 224 with respect to servicing system memory 230 may be implemented on one or both of CPU 216 and system memory 230. Likewise, some or all of the functionality of memory controller 224 with respect to servicing instruction memory 232 may be implemented on one or both of CPU 216 and instruction memory 232.

System memory 230 may store program modules and/or instructions and/or data that are accessible and executed by CPU 216 and/or GPU 218. For example, system memory 230 may store applications that, when executed, provide location support services to UEs as described herein. System memory 230 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media, cloud-based storage medium, or an optical storage media.

CPU 216 may store data to, and read data from, system memory 230 via memory controller 224. For example, CPU 216 may store a working set of instructions to system memory 230, such as instructions loaded from instruction memory 232. CPU 216 may also use system memory 230 to store dynamic data created during the operation of LMF 120. For example, CPU 216 may store measurement data, such as carrier phase measurement data (e.g., received from UEs 130), within system memory 230. CPU 216 may also store assistance data within system memory 230. CPU 116 may comprise a general-purpose or a special-purpose processor that controls operation of LMF 120.

GPU 218 may store data to, and read data from, local memory 220. For example, GPU 218 may store a working set of instructions to local memory 220, such as instructions loaded from instruction memory 232. GPU 218 may also use local memory 220 to store dynamic data created during the operation of LMF 120. Examples of local memory 220 include one or more volatile or non-volatile memories or storage devices, such as RAM, SRAM, DRAM, EPROM, EEPROM, flash memory, a magnetic data media, a cloud-based storage medium, or an optical storage media.

In addition, LMF 120 may include a modulator and/or demodulator 217, either of which may be integrated as part of a combined modulator/demodulator. Modulator/demodulator 217 may include a modulator (e.g., Orthogonal Frequency-Division Multiplexing (OFDM) modulator) that modulates a signal for transmission (e.g., 5G transmission), and/or a demodulator that demodulates a received signal (e.g., from BS 110 or UE 130). In some instances, one or more of CPU 116 and GPU 118 may be configured to provide data to modulator/demodulator 217 for modulation, and to receive demodulated data from modulator/demodulator 217.

Instruction memory 232 may store instructions that may be accessed (e.g., read) and executed by one or more of CPU 216 and GPU 218. For example, instruction memory 232 may store instructions that, when executed by one or more of CPU 216 and GPU 218, cause one or more of CPU 216 and GPU 218 to perform one or more of the operations described herein. For instance, instruction memory 132 can include phase coherency request generation engine 232A and phase coherent resource reporting engine 232B. Phase coherency request generation engine 232A may include instructions that, when executed by one or more of CPU 216 and GPU 218, cause CPU 216 and GPU 218 to generate a DL-PRS configuration request message, as described herein. Further, and when executed by one or more of CPU 216 and GPU 218, the instructions can cause one or more of CPU 216 and GPU 218 to provide the DL-PRS configuration request message to modulator/demodulator 217 for transmission.

Phase coherent resource reporting engine 232B may include instructions that, when executed by one or more of CPU 216 and GPU 218, cause CPU 216 and GPU 218 to generate assistance data identifying resources, such as DL-PRS resources, with phase coherency, as described herein. For instance, the assistance data may identify one or more DL-PRS configurations supported by BS 110. Further, and when executed by one or more of CPU 216 and GPU 218, the instructions can cause one or more of CPU 216 and GPU 218 to provide the assistance data to modulator/demodulator 217 for transmission.

Instruction memory 232 may also store instructions that, when executed by one or more of CPU 116 and GPU 118, cause one or more of camera processor CPU 116 and GPU 118 to perform any suitable LMF function, such as functions that allow for data exchanges with BS 110 and with UEs 130. Instruction memory 232 may include read-only memory (ROM) such as EEPROM, flash memory, a removable disk, CD-ROM, any non-volatile memory, any non-volatile memory, or any other suitable memory.

The various components of LMF 120, as illustrated in FIG. 2, may be configured to communicate with each other across bus 235. Bus 235 may include any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced extensible Interface (AXI) bus), or another type of bus or device interconnect. It is to be appreciated that the specific configuration of components and communication interfaces between the different components shown in FIG. 2 is merely exemplary, and other configurations of the components, and/or other image processing systems with the same or different components, may be configured to implement the operations and processes of this disclosure.

As described herein, one or more of CPU 216 and GPU 218 may perform operations that generate a DL-PRS configuration request message that includes a request for DL-PRS configurations with DL-PRS resources that are phase coherent, and that transmit the DL-PRS configuration request message to BS 110. The one or more of CPU 216 and GPU 218 may also perform operations that receive a DL-PRS configuration response message, and parse the DL-PRS configuration response message to determine, among other things, DL-PRS resources that are phase coherent (e.g., resources that, when transmitted, are transmitted at initial phases that are within a range). One or more of CPU 216 and GPU 218 may perform further operations that receive a request for assistance data that includes phase coherent DL-PRS resources, such as DL-PRS configurations with phase coherent DL-PRS resources, and that generate and transmit assistance data that identifies the DL-PRS resources that are phase coherent (e.g., based on DL-PRS configurations received from base stations, such as BS 110).

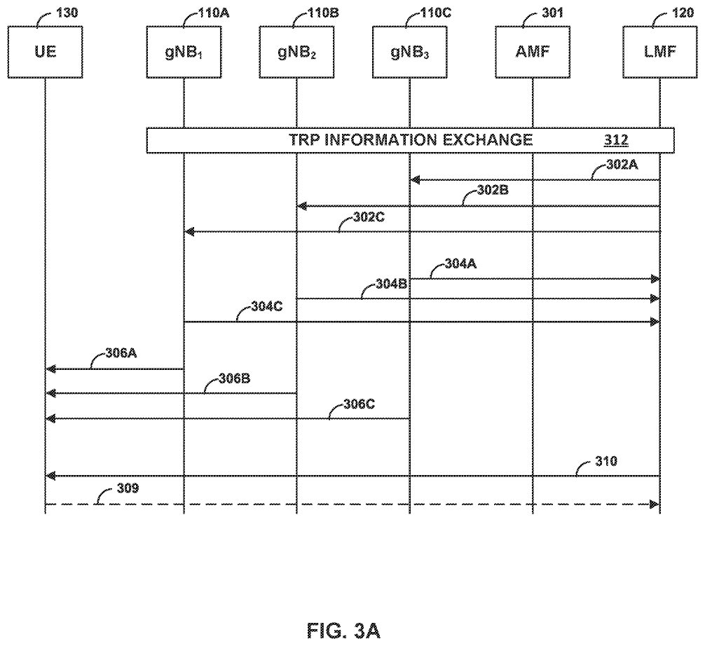

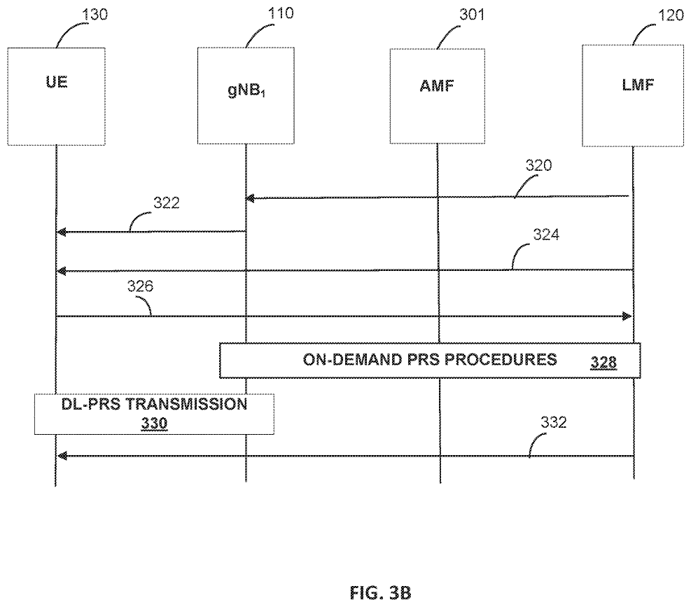

FIG. 3A illustrates messaging among a UE 130, BSs 110a (e.g., gNBs), 110b, 110c, AMF 301, and LMF 120. Initially, transmission reception point (TRP) information 312 is exchanged between the BSs 110a, 110b, 110c and LMF 120. For instance, BS 110 may transmit DL-PRS configuration information to LMF 120, such as one or more of a resource set periodicity, a PRS bandwidth, a resource repetition value, a resource number of symbols, a comb size, a of frequency layers, a start time and duration, an off indication, Quasi Co Location (QCL) data, PRS phase coherence data identifying phase coherent resources, an antenna port for the phase coherent resources, a time gap between resources (e.g., a time gap value), and a number of repeated slots for the resources (e.g., a repetition value). As a result, for example, LMF 120 may detect and identify the BSs 110a, 110b, 110c. Further, LMF 120 may generate and transmit a DL-PRS configuration request 302a, 302b, 302c (e.g., for DL-PRS transmission characteristics and transmission off information) to each BS 110a, 110b, 110c, each of which includes a request for DL-PRS configurations that include phase coherent DL-PRS resources, and receive, in response, a DL-PRS configuration response 304a, 304b, 304c characterizing a corresponding DL-PRS configuration. For example, LMF 120 may generate and transmit DL-PRS configuration request 302a to BS 110c. In response, BS 110c may generate and transmit to LMF 120 DL-PRS configuration response 304a. Similarly, LMF 120 may generate and transmit DL-PRS configuration request 302b to BS 110b and DL-PRS configuration request 302c to BS 110a, and may receive, respectively from BS 110b and BS 110a, DL-PRS configuration response 304b and DL-PRS configuration response 304c. LMF 120 may store the DL-PRS configurations for each BS 110a, 110b, 110c in a data repository, such as system memory 230.

Based on the DL-PRS configurations, each BS 110a, 110b, 110c may begin DL-PRS transmissions (e.g., downlink transmissions) to UE 130 using, for example, the DL-PRS configuration reported within DL-PRS configuration responses 304c, 304b, 304a. For example, BS 110a may begin DL-PRS transmissions 306a to UE 130 using the DL-PRS configuration reported within DL-PRS configuration responses 304c. Similarly, BS 110b may begin DL-PRS transmissions 306b to UE 130 using the DL-PRS configuration reported within DL-PRS configuration responses 304b, and BS 110c may begin DL-PRS transmissions 306c to UE 130 using the DL-PRS configuration reported within DL-PRS configuration responses 304a.

In some examples, LMF 120 generates and transmits assistance data 310 that identifies DL-PRS resources with initial transmission phase coherency. For instance, the assistance data 310 may identify DL-PRS resources with a same initial transmission phase. As described herein, LMF 120 may also generate assistance data 310 that identifies a repetition value and a time gap value for the DL-PRS resources. LMF 120 transmits the assistance data 310 to UE 130. For instance, LMF 120 may broadcast the assistance data 310 (e.g., as a broadcast message), and any connected UEs, such as UE 130, may receive the assistance data 310. In some examples, UE 130 transmits an assistance data request 309 to LMF 120 requesting DL-PRS configurations with phase coherent DL-PRS resources. In response, LMF 120 transmits the assistance data 310 to UE 130.

In some instances, as described herein, LMF 120 generates assistance data 310 that identifies one or more DL-PRS configurations, and includes a profile ID for each of the DL-PRS configurations. For instance, and with reference to FIG. 3B, LMF 120 may generate and transmit positioning assistance data 320 to BS 110 (e.g., while performing assistance information control procedures). Further, BS 110 may generate and transmit system information 322 to UE 130. System information 322 may include, for example, frame number, bandwidth, and cell selection and re-selection thresholds to access the network provided by BS 110.

In addition, LMF 120 may transmit, to UE 130, assistance data 324 that identifies one or more DL-PRS configurations for BS 110. The DL-PRS configurations may be based on DL-PRS configuration information received from BS 110 as described herein. For example, and during on-demand PRS procedures 328, LMF 120 may generate and transmit a DL-PRS configuration request to BS 110, which includes a request for DL-PRS configurations with phase coherent DL-PRS resources. In response, LMF 120 may receive, from BS 110, a DL-PRS configuration response characterizing a corresponding DL-PRS configuration. LMF 120 may assign a profile ID to each DL-PRS configuration, and may generate the assistance data 324 to include the profile ID for each DL-PRS configuration. LMF 120 may transmit the assistance data 324 to UE 130.

UE 130 may select one of the DL-PRS configurations identified within the received assistance data 324 based on the profile IDs, and may generate a profile selection message 326 (e.g., a request assistance data message) that includes the profile ID for the selected DL-PRS configuration. UE 130 may transmit the profile selection message 326 to LMF 120. LMF 120 may receive the profile selection message 326, and may attempt to update BS 110 (e.g., using on-demand PRS procedures 328 as described herein) to operate using the DL-PRS configuration identified within the profile selection message 326. Upon receiving profile selection message 326, BS 110 may determine whether it can operate in accordance with the DL-PRS configuration identified within the profile selection message 326. If BS 110 determines that it may operate in accordance with the DL-PRS configuration identified within the profile selection message 326, BS 110 may update its current DL-PRS configuration accordingly.

LMF 120 may, in some examples, receive DL-PRS configuration information from BS 110 identifying the current DL-PRS configuration. Further, LMF 120 may generate additional assistance data 332 identifying the current DL-PRS configuration of BS 110. The current DL-PRS configuration may correspond to the selected DL-PRS configuration if configuration of BS 110 was successful. LMF 120 may transmit the additional assistance data 332 to UE 130. BS 110 may begin DL-PRS transmissions 330 (e.g., downlink transmissions) to UE 130 while operating under, for example, the DL-PRS configuration identified within the profile selection response 326.

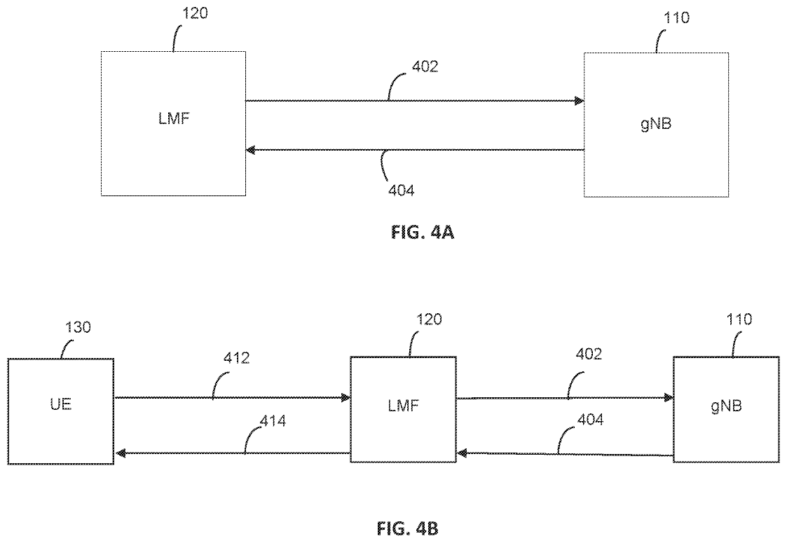

FIG. 4A illustrates exemplary messaging between LMF 120 and BS 110 to determine DL-PRS resources with phase coherency, such as DL-PRS resources transmitted with an initial phase within a range of each other (e.g., 5 degrees). In this example, LMF 120 generates a DL-PRS configuration request 402 requesting DL-PRS resources that are phase coherent, and transmits the DL-PRS configuration request 402 to BS 110. In response to receiving DL-PRS configuration request 402, BS 110 determines DL-PRS resources in accordance with the request. For example, in some instances, the DL-PRS configuration request 402 identifies the range. BS 110 may determine DL-PRS resources that are transmitted with an initial phase that are within the specified range of each other.

In some examples, the DL-PRS configuration request 402 includes a repetition value identifying, for example, a number of repeated slots. For instance, the DL-PRS configuration request 402 may include a repetition value of one, two, four, six, or any other suitable value. In response to receiving the DL-PRS configuration request 402, BS 110 may determine DL-PRS resources that are phase coherent and that include at least the number of repeated slots. For instance, if the maximum number of repeated slots is four, BS 110 may determine phase coherent DL-PRS resources that can be allocated to at least four slots per resource. In some examples, the DL-PRS configuration request includes a time gap value identifying a maximum number of other slots between two consecutive DL-PRS resource slots, such as two, four, or any other suitable value. For instance, if the maximum number of other slots is two, BS 110 may determine phase coherent DL-PRS resources that can allocate slots that are separated by at most two slots (i.e., 0, 1, or 2 slots).

Based on the determined DL-PRS resources, BS 110 generates a DL-PRS configuration response 404 identifying the determined DL-PRS resources, and transmits the DL-PRS configuration response 404 to LMF 120. As described herein, LMF 120 may generate assistance data based on the DL-PRS resources identified within the DL-PRS configuration response 404, and may transmit the assistance data to one or more UEs 130.

In some examples, a UE 130 may request, from LMF 120, DL-PRS resources with phase continuity, as described herein. For example, and with reference to FIG. 4B, UE 130 may generate an assistance data request 412 that includes a request for DL-PRS configurations with phase coherent DL-PRS resources. In some examples, the UE 130 generates assistance data request 412 to request phase coherent slots that does not require a certain number of slot repetitions (e.g., repetition value=0), and does not require a maximum number of other slots between two consecutive resource slots of a same DL-PRS resource (e.g., time gap value=undefined). In some examples, the UE 130 generates assistance data request 412 to request phase coherent slots, and further requires at least one of a certain number of slot repetitions (e.g., repetition value=2), and a maximum number of other slots between two consecutive resource slots of a same DL-PRS resource (e.g., time gap value=2).

The UE 130 may transmit the assistance data request 412 to LMF 120. In response, LMF 120 may generate assistance data 414 based on any DL-PRS configurations identified within DL-PRS configuration responses 404 that identify DL-PRS resources that are phase coherent and, in addition, that satisfy any other request. For instance, LMF 120 may determine DL_PRS resources that satisfy any requested number of slot repetitions, or any requested maximum number of other slots between two consecutive resource slots of a same DL-PRS resource. LMF 120 may transmit the assistance data 414 to UE 130. UE 130 may determine measurements, such as location measurements and carrier phase measurements, based on the DL-PRS resources with phase coherency, and may transmit the measurements to BS 110.

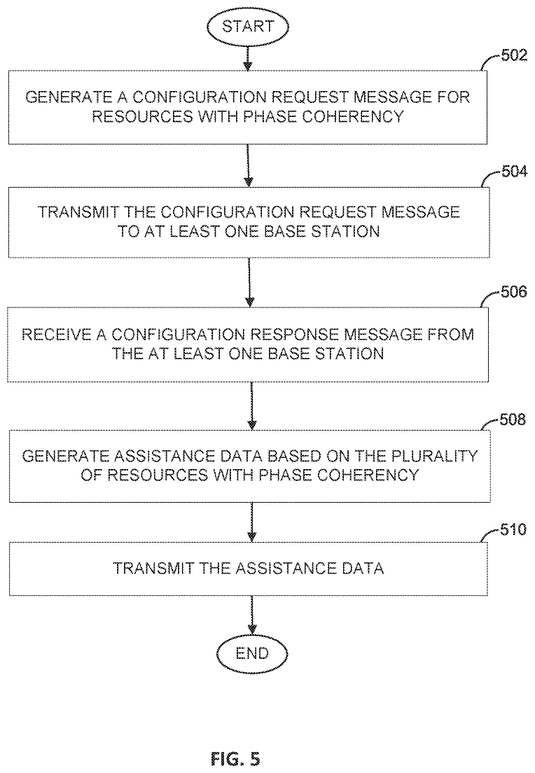

FIG. 5 is a flowchart of an example process 500 for generating assistance data that identifies resources with phase coherency. Process 500 may be performed by one or more processors executing instructions locally at a computing device, such as by one or more of CPU 116 and GPU 118 of LMF 120 of FIGS. 1 and 2. Accordingly, the various operations of process 500 may be represented by executable instructions held in storage media of one or more computing platforms, such as instruction memory 232 of LMF 120.

Beginning at block 502, LMF 120 generates a configuration request message for resources with phase coherency. For instance, LMF 120 may generate a DL-PRS configuration request 402 for DL-PRS resources that are phase coherent. In some examples, the configuration request message includes a range of phases, where DL-PRS resources transmitted at an initial transmission phase within the range of phases are phase coherent. In other examples, the configuration request message may include, for example, one or more of a repetition value and a time gap value.

At step 504, LMF 120 transmits the configuration request message to at least one base station. For instance, LMF 120 may transmit the DL-PRS configuration request 402 to BS 110. BS 110 may determine DL-PRS resources based on the DL-PRS configuration request 402. For instance, and assuming the DL-PRS configuration request 402 identifies a range of phases, BS 110 may determine DL-PRS resources that are transmitted with a phase within the range of phases. In examples when the configuration request message includes a repetition value, BS 110 may determine DL-PRS resources that are phase coherent and can be allocated to the number of repeated slots identified by the repetition value. In examples when the configuration request message includes a time gap value, BS 110 may determine DL-PRS resources that are phase coherent and can be allocated such that no more than a maximum number of slots, as identified by the time gap value, are allocated between two consecutive resource slots of the same DL-PRS resource.

Further, and at step 506, LMF 120 receives a configuration response message from the at least one base station. The configuration request message identifies a plurality of resources with phase coherency. For example, in response to receiving the DL-PRS configuration request 402, BS 110 generates a DL-PRS configuration response 404 identifying the determined DL-PRS resources, and transmits the DL-PRS configuration response 404 to LMF 120. At step 508, LMF 120 generates assistance data based on the plurality of resources with phase coherency. For example, LMF 120 may generate assistance data 414 based on any DL-PRS configurations identified within received DL-PRS configuration responses 404 that identify DL-PRS resources that are phase coherent. At step 510, LMF 120 transmits the assistance data. For example, LMF 120 may broadcast the assistance data identifying the DL-PRS resources that are phase coherent, which may be received by one or more UEs 130.

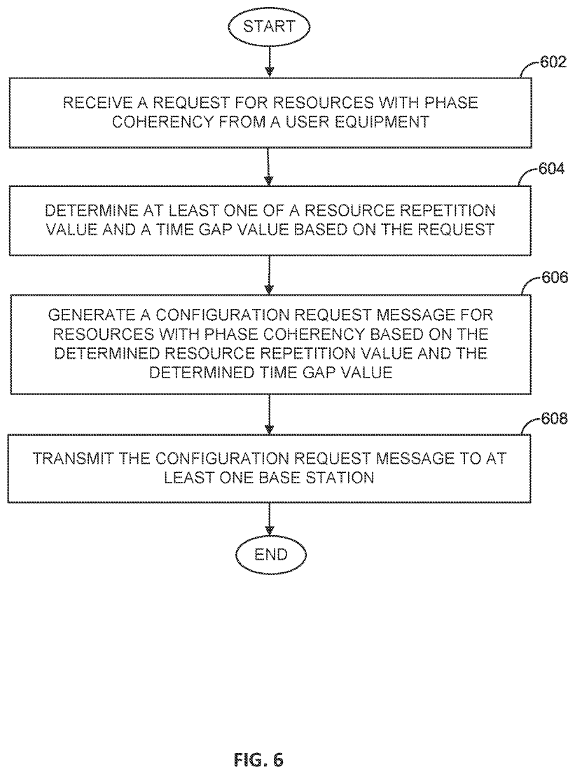

FIG. 6 is a flowchart of an example process 600 for generating a resource request message for resources with phase coherency. Process 600 may be performed by one or more processors executing instructions locally at a computing device, such as by one or more of CPU 116 and GPU 118 of LMF 120 of FIGS. 1 and 2. Accordingly, the various operations of process 600 may be represented by executable instructions held in storage media of one or more computing platforms, such as instruction memory 232 of LMF 120.

Beginning at block 602, LMF 120 receives a request for resources with phase coherency from a user equipment. For instance, LMF 120 may receive an assistance data request 412 from a UE 130 for DL-PRS configurations with phase coherent DL-PRS resources. At step 604, LMF 120 determines at least one of a resource repetition value and a time gap value based on the request. For example, LMF 120 may determine whether the request for resources with phase coherency includes a valid resource repetition value, such as a resource repetition value within a resource repetition range. If the request for resource with phase coherency does not include a valid resource repetition value, LMF 120 determines that no repeated slots are being requested, and sets the resource repetition value to a default value (e.g., a value indicating no resource repetition requested). Similarly, LMF 120 may determine whether the request for resources with phase coherency includes a valid time gap value, such as a time gap value within a time gap range. If the request for resource with phase coherency does not include a valid time gap value, LMF 120 determines that no time gap is requested, and sets the time gap value to a default value (e.g., a value indicating no time gap requested).

Proceeding to step 606, LMF 120 generates a configuration request message for resources with phase coherency based on the determined resource repetition value and the determined time gap value. For instance, LMF 120 may generate a DL-PRS configuration request 402 for DL-PRS resources that are phase coherent, where the DL-PRS configuration request 402 includes the determined resource repetition value and the determined time gap value. At step 608, LMF 120 transmits the configuration request message to at least one base station. For instance, LMF 120 may transmit the DL-PRS configuration request 402 to BS 110.

In some instances, in response to receiving the DL-PRS configuration request 402, BS 110 generates a DL-PRS configuration response 404 identifying the determined DL-PRS resources, and transmits the DL-PRS configuration response 404 to LMF 120. LMF 120 may then generate assistance data based on the DL-PRS resources, and transmits the assistance data to the user equipment (e.g., UE 130).

Implementation examples are further described in the following numbered clauses:
1. An apparatus comprising:
a non-transitory, machine-readable storage medium storing instructions; and
at least one processor coupled to the non-transitory, machine-readable storage medium, the at least one processor being configured to:
   generate a configuration request message for resources with phase coherency;
   transmit the configuration request message to at least one base station, the configuration request message causing the at least one base station to determine a plurality of resources with phase coherency;
   receive a configuration response message from the at least one base station, wherein the configuration response message identifies a plurality of resources with phase coherency;
   generate assistance data based on the plurality of resources with phase coherency; and
   transmit the assistance data.
2. The apparatus of clause 1, wherein the at least one processor is further configured to execute the instructions to:
generate the configuration request message to include a time gap value;
receive the configuration message from the at least one base station, wherein at least a portion of the plurality of resources satisfy the time gap value; and
generate the assistance data based on the portion of the plurality of resources that satisfy the time gap value.
3. The apparatus of any of clauses 1-2, wherein the at least one processor is further configured to execute the instructions to:
generate the configuration request message to include a resource repetition value;
receive the configuration message from the at least one base station, wherein at least a portion of the plurality of resources satisfy the resource repetition value; and
generate the assistance data based on the portion of the plurality of resources that satisfy the resource repetition value.
4. The apparatus of any of clauses 1-3, wherein the resources with phase coherency are downlink positioning reference signal (DL-PRS) resources.
5. The apparatus of any of clauses 1-4, wherein the at least one processor is further configured to execute the instructions to:
receive an assistance data request message from a user equipment (UE); and
transmit the assistance data in response to the assistance data request message.
6. The apparatus of clause 5, wherein the at least one processor is further configured to execute the instructions to:
determine the assistance data request message includes at least one of a time gap value and a repetition value; and
generate the configuration request message to include the at least one of the time gap value and the repetition value.
7. The apparatus of any of clauses 1-6, wherein the configuration response message comprises at least one downlink positioning reference signal (DL-PRS) configuration, wherein the at least one DL-PRS configuration includes the plurality of resources with phase coherency, and wherein the at least one processor is further configured to execute the instructions to:
assign a profile identification (ID) to the at least one DL-PRS configuration; and
generate the assistance data to include the profile ID.
8. The apparatus of clause 7, wherein the at least one processor is further configured to execute the instructions to:
receive an assistance data request message from a user equipment (UE);
determine the assistance data request message includes the profile ID.
9. The apparatus of clause 8, wherein the at least one processor is further configured to execute the instructions to:
generate an additional configuration request message identifying the at least one DL-PRS configuration; and
transmit the additional configuration request message to the at least one base station.
10. A method comprising:
generating a configuration request message for resources with phase coherency;
transmitting the configuration request message to at least one base station, the configuration request message causing the at least one base station to determine a plurality of resources with phase coherency;
receiving a configuration response message from the at least one base station, wherein the configuration response message identifies a plurality of resources with phase coherency;
generating assistance data based on the plurality of resources with phase coherency; and
transmitting the assistance data.
11. The method of clause 10, comprising:
generating the configuration request message to include a time gap value;
receiving the configuration message from the at least one base station, wherein at least a portion of the plurality of resources satisfy the time gap value; and
generating the assistance data based on the portion of the plurality of resources that satisfy the time gap value.
12. The method of any of clauses 10-11, comprising:
generating the configuration request message to include a resource repetition value;
receiving the configuration message from the at least one base station, wherein at least a portion of the plurality of resources satisfy the resource repetition value; and
generating the assistance data based on the portion of the plurality of resources that satisfy the resource repetition value.
13. The method of any of clauses 10-12, wherein the resources with phase coherency are downlink positioning reference signal (DL-PRS) resources.
14. The method of any of clauses 10-13, comprising:
receiving an assistance data request message from a user equipment (UE); and
transmitting the assistance data in response to the assistance data request message.
15. The method of clause 14, comprising:
determining the assistance data request message includes at least one of a time gap value and a repetition value; and
generating the configuration request message to include the at least one of the time gap value and the repetition value.
16. The method of any of clauses 10-15, wherein the configuration response message comprises at least one downlink positioning reference signal (DL-PRS) configuration, wherein the at least one DL-PRS configuration includes the plurality of resources with phase coherency, the method comprising:
assigning a profile identification (ID) to the at least one DL-PRS configuration; and
generating the assistance data to include the profile ID.
17. The method of clause 16, comprising:
receiving an assistance data request message from a user equipment (UE);
determining the assistance data request message includes the profile ID.
18. The method of clause 17, comprising:
generating an additional configuration request message identifying the at least one DL-PRS configuration; and
transmitting the additional configuration request message to the at least one base station.
19. A non-transitory, machine-readable storage medium storing instructions that, when executed by at least one processor, causes the at least one processor to perform operations that include:
generating a configuration request message for resources with phase coherency;
transmitting the configuration request message to at least one base station, the configuration request message causing the at least one base station to determine a plurality of resources with phase coherency;
receiving a configuration response message from the at least one base station, wherein the configuration response message identifies a plurality of resources with phase coherency;
generating assistance data based on the plurality of resources with phase coherency; and
transmitting the assistance data.
20. The non-transitory, machine-readable storage medium of clause 19, wherein the instructions, when executed by the at least one processor, cause the at least one processor to perform operations that include:
generating the configuration request message to include a time gap value;
receiving the configuration message from the at least one base station, wherein at least a portion of the plurality of resources satisfy the time gap value; and generating the assistance data based on the portion of the plurality of resources that satisfy the time gap value.
21. The non-transitory, machine-readable storage medium of any of clauses 19-20, wherein the instructions, when executed by the at least one processor, cause the at least one processor to perform operations that include:
generating the configuration request message to include a resource repetition value;
receiving the configuration message from the at least one base station, wherein at least a portion of the plurality of resources satisfy the resource repetition value; and
generating the assistance data based on the portion of the plurality of resources that satisfy the resource repetition value.
22. The non-transitory, machine-readable storage medium of any of clauses 19-21, wherein the resources with phase coherency are downlink positioning reference signal (DL-PRS) resources.
23. The non-transitory, machine-readable storage medium of any of clauses 19-12, comprising:
receiving an assistance data request message from a user equipment (UE); and
transmitting the assistance data in response to the assistance data request message.
24. The non-transitory, machine-readable storage medium of clause 23, comprising:
determining the assistance data request message includes at least one of a time gap value and a repetition value; and
generating the configuration request message to include the at least one of the time gap value and the repetition value.
25. The non-transitory, machine-readable storage medium of any of clauses 19-24, wherein the configuration response message comprises at least one downlink positioning reference signal (DL-PRS) configuration, wherein the at least one DL-PRS configuration includes the plurality of resources with phase coherency, the method comprising:
assigning a profile identification (ID) to the at least one DL-PRS configuration; and
generating the assistance data to include the profile ID.
26. The non-transitory, machine-readable storage medium of clause 25, comprising:
receiving an assistance data request message from a user equipment (UE);
determining the assistance data request message includes the profile ID.
27. The non-transitory, machine-readable storage medium of clause 26, comprising:
generating an additional configuration request message identifying the at least one DL-PRS configuration; and
transmitting the additional configuration request message to the at least one base station.
28. An image capture device comprising:
a means for generating a configuration request message for resources with phase coherency;
a means for transmitting the configuration request message to at least one base station, the configuration request message causing the at least one base station to determine a plurality of resources with phase coherency;
a means for receiving a configuration response message from the at least one base station, wherein the configuration response message identifies a plurality of resources with phase coherency;
a means for generating assistance data based on the plurality of resources with phase coherency; and
a means for transmitting the assistance data.
29. The image capture device of clause 28, comprising:
generating the configuration request message to include a time gap value;
receiving the configuration message from the at least one base station, wherein at least a portion of the plurality of resources satisfy the time gap value; and
generating the assistance data based on the portion of the plurality of resources that satisfy the time gap value.
30. The image capture device of any of clauses 28-29, comprising:
generating the configuration request message to include a resource repetition value;
receiving the configuration message from the at least one base station, wherein at least a portion of the plurality of resources satisfy the resource repetition value; and
generating the assistance data based on the portion of the plurality of resources that satisfy the resource repetition value.
31. The image capture device of any of clauses 28-30, wherein the resources with phase coherency are downlink positioning reference signal (DL-PRS) resources.
32. The image capture device of any of clauses 28-31, comprising:
receiving an assistance data request message from a user equipment (UE); and
transmitting the assistance data in response to the assistance data request message.
33. The image capture device of clause 32, comprising:
determining the assistance data request message includes at least one of a time gap value and a repetition value; and
generating the configuration request message to include the at least one of the time gap value and the repetition value.
34. The image capture device of any of clauses 28-33, wherein the configuration response message comprises at least one downlink positioning reference signal (DL-PRS) configuration, wherein the at least one DL-PRS configuration includes the plurality of resources with phase coherency, the method comprising:
assigning a profile identification (ID) to the at least one DL-PRS configuration; and
generating the assistance data to include the profile ID.
35. The image capture device of clause 34, comprising:
receiving an assistance data request message from a user equipment (UE);
determining the assistance data request message includes the profile ID.
36. The image capture device of clause 35, comprising:
generating an additional configuration request message identifying the at least one DL-PRS configuration; and
transmitting the additional configuration request message to the at least one base station.

Although the methods described above are with reference to the illustrated flowcharts, many other ways of performing the acts associated with the methods may be used. For example, the order of some operations may be changed, and some embodiments may omit one or more of the operations described and/or include additional operations.

Additionally, the methods and system described herein may be at least partially embodied in the form of computer-implemented processes and apparatus for practicing those processes. The disclosed methods may also be at least partially embodied in the form of tangible, non-transitory machine-readable storage media encoded with computer program code. For example, the methods may be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, computer program code segments configure the processor to create specific logic circuits. The methods may alternatively be at least partially embodied in application specific integrated circuits for performing the methods.

We claim:

1. An apparatus comprising:
a non-transitory, machine-readable storage medium storing instructions; and
at least one processor coupled to the non-transitory, machine-readable storage medium, the at least one processor being configured to:
generate a configuration request message for resources with phase coherency;
transmit the configuration request message to at least one base station, the configuration request message causing the at least one base station to determine a plurality of resources with phase coherency;
receive a configuration response message from the at least one base station, wherein the configuration response message identifies the plurality of resources with phase coherency;
generate assistance data based on the plurality of resources with phase coherency; and
transmit the assistance data.

2. The apparatus of claim 1, wherein the at least one processor is further configured to execute the instructions to:
generate the configuration request message to include a time gap value;
receive the configuration message from the at least one base station, wherein at least a portion of the plurality of resources satisfy the time gap value; and
generate the assistance data based on the portion of the plurality of resources that satisfy the time gap value.

3. The apparatus of claim 1, wherein the at least one processor is further configured to execute the instructions to:
generate the configuration request message to include a resource repetition value;
receive the configuration message from the at least one base station, wherein at least a portion of the plurality of resources satisfy the resource repetition value; and
generate the assistance data based on the portion of the plurality of resources that satisfy the resource repetition value.

4. The apparatus of claim 1, wherein the resources with phase coherency are downlink positioning reference signal (DL-PRS) resources.

5. The apparatus of claim 1, wherein the at least one processor is further configured to execute the instructions to:
receive an assistance data request message from a user equipment (UE); and
transmit the assistance data in response to the assistance data request message.

6. The apparatus of claim 5, wherein the at least one processor is further configured to execute the instructions to:
determine the assistance data request message includes at least one of a time gap value and a repetition value; and
generate the configuration request message to include the at least one of the time gap value and the repetition value.

7. The apparatus of claim 1, wherein the configuration response message comprises at least one downlink positioning reference signal (DL-PRS) configuration, wherein the at least one DL-PRS configuration includes the plurality of resources with phase coherency, and wherein the at least one processor is further configured to execute the instructions to:
assign a profile identification (ID) to the at least one DL-PRS configuration; and
generate the assistance data to include the profile ID.

8. The apparatus of claim 7, wherein the at least one processor is further configured to execute the instructions to:
receive an assistance data request message from a user equipment (UE);
determine the assistance data request message includes the profile ID.

9. The apparatus of claim 8, wherein the at least one processor is further configured to execute the instructions to:
generate an additional configuration request message identifying the at least one DL-PRS configuration; and
transmit the additional configuration request message to the at least one base station.

10. A method comprising:
generating a configuration request message for resources with phase coherency;
transmitting the configuration request message to at least one base station, the configuration request message causing the at least one base station to determine a plurality of resources with phase coherency;
receiving a configuration response message from the at least one base station, wherein the configuration response message identifies a plurality of resources with phase coherency;
generating assistance data based on the plurality of resources with phase coherency; and
transmitting the assistance data.

11. The method of claim 10, comprising:
generating the configuration request message to include a time gap value;
receiving the configuration message from the at least one base station, wherein at least a portion of the plurality of resources satisfy the time gap value; and
generating the assistance data based on the portion of the plurality of resources that satisfy the time gap value.

12. The method of claim 10, comprising:
generating the configuration request message to include a resource repetition value;
receiving the configuration message from the at least one base station, wherein at least a portion of the plurality of resources satisfy the resource repetition value; and
generating the assistance data based on the portion of the plurality of resources that satisfy the resource repetition value.

13. The method of claim 10, comprising:
receiving an assistance data request message from a user equipment (UE); and
transmitting the assistance data in response to the assistance data request message.

14. The method of claim 13, comprising:
determining the assistance data request message includes at least one of a time gap value and a repetition value; and
generating the configuration request message to include the at least one of the time gap value and the repetition value.

15. The method of claim 10, wherein the configuration response message comprises at least one downlink positioning reference signal (DL-PRS) configuration, wherein the at least one DL-PRS configuration includes the plurality of resources with phase coherency, the method comprising:
assigning a profile identification (ID) to the at least one DL-PRS configuration; and
generating the assistance data to include the profile ID.

16. The method of claim 15, comprising:
receiving an assistance data request message from a user equipment (UE);
determining the assistance data request message includes the profile ID.

17. The method of claim 16, comprising:
generating an additional configuration request message identifying the at least one DL-PRS configuration; and
transmitting the additional configuration request message to the at least one base station.

18. A non-transitory, machine-readable storage medium storing instructions that, when executed by at least one processor, causes the at least one processor to perform operations that include:
generating a configuration request message for resources with phase coherency;
transmitting the configuration request message to at least one base station, the configuration request message causing the at least one base station to determine a plurality of resources with phase coherency;
receiving a configuration response message from the at least one base station, wherein the configuration response message identifies a plurality of resources with phase coherency;
generating assistance data based on the plurality of resources with phase coherency; and
transmitting the assistance data.

19. The non-transitory, machine-readable storage medium of claim 18, wherein the instructions, when executed by the at least one processor, cause the at least one processor to perform operations that include:
generating the configuration request message to include a time gap value;
receiving the configuration message from the at least one base station, wherein at least a portion of the plurality of resources satisfy the time gap value; and
generating the assistance data based on the portion of the plurality of resources that satisfy the time gap value.

20. The non-transitory, machine-readable storage medium of claim 18, wherein the instructions, when executed by the at least one processor, cause the at least one processor to perform operations that include:
generating the configuration request message to include a resource repetition value;
receiving the configuration message from the at least one base station, wherein at least a portion of the plurality of resources satisfy the resource repetition value; and
generating the assistance data based on the portion of the plurality of resources that satisfy the resource repetition value.
